(19) United States
(12) Patent Application Publication
(10) Pub. No.: US 2011/0188437 A1
(43) Pub. Date: Aug. 4, 2011

(54) RECEPTION OF PARALLEL WARNING MESSAGES

(75) Inventor: Masato Kitazoe, Tokyo (JP)

(73) Assignee: QUALCOMM INCORPORATED, San Diego, CA (US)

(21) Appl. No.: 12/851,736

(22) Filed: Aug. 6, 2010

Related U.S. Application Data
(60) Provisional application No. 61/232,355, filed on Aug. 7, 2009.

(51) Int. Cl. H04H 20/71

(52) U.S. Cl. 370/312

(57) ABSTRACT

Systems, methods and apparatus described herein include features that enable the reception of multiple warning messages. In one embodiment, the access point transmits a list of warning messages. Using the list a UE is able to determine whether all of the currently available warning messages have been received, and in turn, whether to maintain open reception in order to enable reception of the warning messages on the list that have not been fully received. In another embodiment, the access point transmits an indicator of a counter value. Using the indicator of the counter value a UE is able to decipher how many warning messages are being currently transmitted. In another embodiment, an access point transmits an indicator that the number of available warning messages has changed. In turn, a UE is able to determine whether or not to check for a new list or indicator of a counter value.

### CLAIM OF PRIORITY UNDER 35 U.S.C. §119

The present Application for Patent claims priority to U.S. Provisional Application No. 61/232,355, entitled “METHOD AND APPARATUS TO ENABLE RECEPTION OF PARALLEL WARNING MESSAGES,” filed Aug. 7, 2009. The above-referenced provisional patent application is hereby expressly incorporated by reference herein.

### BACKGROUND

1. Field

The present application relates to wireless networks, and more specifically to systems, methods and apparatus to enable reception of multiple warning messages.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power).

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

To supplement conventional mobile phone network base stations, additional base stations may be deployed to provide more robust wireless coverage to mobile units. For example, wireless relay stations and small-coverage base stations (e.g., commonly referred to as access point base stations, Home NodeBs, femto access points, or femto cells) may be deployed for incremental capacity growth, richer user experience, and in-building coverage. Typically, such small-coverage base stations are connected to the Internet and the mobile operator's network via DSL router or cable modem. As these other types of base stations may be added to the conventional mobile phone network (e.g., the backhaul) in a different manner than conventional base stations (e.g., macro base stations), there is a need for effective techniques for managing these other types of base stations and their associated user equipment.

### SUMMARY

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various embodiments are used to enable reception of multiple warning messages.

One aspect of the disclosure is a method of receiving one or more warning messages; generating a first indicator of the number of warning messages that an access point will broadcast to access terminals; and transmitting the first indicator to one or more access terminals in response to receiving the one or more and subsequently received warning messages.

One aspect of the disclosure is a method of receiving a first indicator of the number of warning messages that an access point will broadcast to access terminals; and maintaining open reception on the wireless channel until at least one of: all the warning messages available as indicated by the first indicator are received and the access point instructs the access terminal to stop reception.

One aspect of the disclosure is a wireless access point including means for receiving one or more warning messages; means for generating a first indicator of the number of warning messages that an access point will broadcast to access terminals; and means for transmitting the first indicator to one or more access terminals in response to receiving the one or more and subsequently received warning messages.

One aspect of the disclosure is a wireless access terminal including means for receiving a first indicator of the number of warning messages that an access point will broadcast to access terminals; and means for maintaining open reception on the wireless channel until at least one of: all the warning messages available as indicated by the first indicator are received and the access point instructs the access terminal to stop reception.

One aspect of the disclosure is a wireless access point including a controller configured to execute code; and non-transitory computer readable memory storing code that when executed by the controller is configured to: receive one or more warning messages; generate a first indicator of the number of warning messages that an access point will broadcast to access terminals; and transmit the first indicator to one or more access terminals in response to receiving the one or more and subsequently received warning messages.

One aspect of the disclosure is a wireless access terminal including a controller configured to execute code; and non-transitory computer readable memory storing code that when executed by the controller is configured to: receive a first indicator of the number of warning messages that an access point will broadcast to access terminals; and maintain open reception on the wireless channel until at least one of: all the warning messages available as indicated by the first indicator are received and the access point instructs the access terminal to stop reception.

### BRIEF DESCRIPTION OF THE DRAWINGS

FIG. 1 is a simplified diagram of a wireless communication system.

FIG. 2 is a simplified diagram of a wireless communication system including femto nodes.

FIG. 3 is a simplified diagram illustrating coverage areas for wireless communication.

FIG. 4 is a simplified block diagram of several sample aspects of communication components.

FIG. 5 is a simplified block diagram of several sample aspects of a communication system.

FIG. 6 is a signaling diagram illustrating communication of multiple warning messages within the system of FIG. 5.

FIG. 7 is a flowchart illustrating a first method of enabling reception of multiple warning messages.

FIG. 8 is a flowchart illustrating a second method of enabling reception of multiple warning messages.

FIG. 9 is a flowchart illustrating a third method of enabling reception of multiple warning messages.

FIG. 10 is a flowchart illustrating a fourth method of enabling reception of multiple warning messages.

FIG. 11 is a flowchart illustrating a fifth method of enabling reception of multiple warning messages.

FIG. 12 is a flowchart illustrating a sixth method of enabling reception of multiple warning messages.

FIGS. 13-23 are simplified block diagrams of several sample aspects of apparatuses configured to provide provisioning and/or access management as taught herein.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of embodiments within the scope of the appended claims are described below. It should be apparent that the aspects described herein may be embodied in a wide variety of forms and that any specific structure and/or function described herein is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). Similarly, cdma2000 is described in documents from an organization named “3rd Generation Partnership Project 2” (3GPP2). These various radio technologies and standards are known in the art.

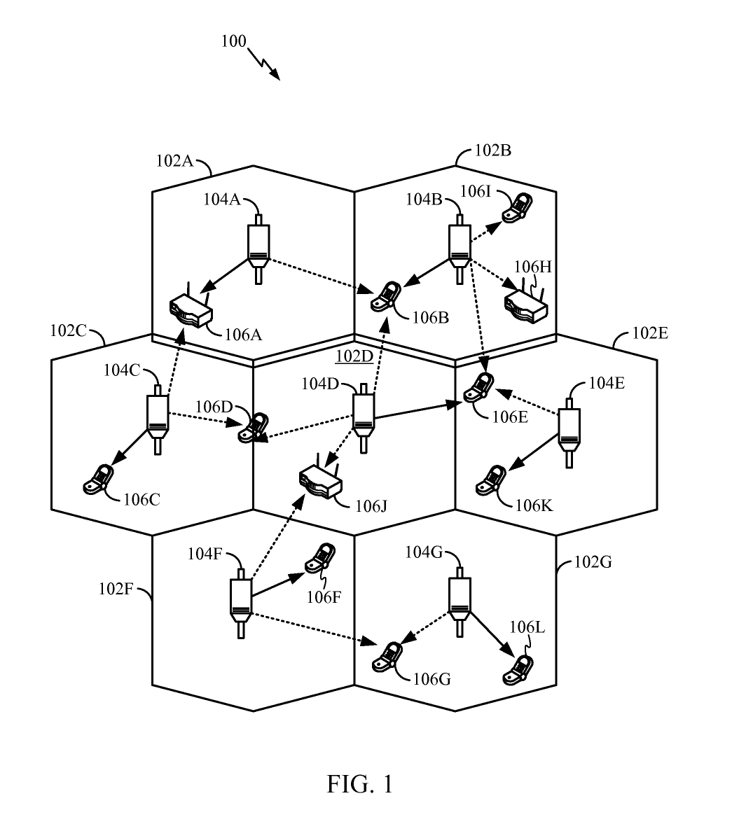

FIG. 1 is a simplified diagram of a wireless communication system 100, configured to support a number of users, in which the teachings herein may be implemented. The system 100 provides communication for multiple cells 102, such as, for example, macro cells 102A-102G, with each cell being serviced by a corresponding access point 104 (e.g., access points 104A-104G). Access terminals 106 (e.g., access terminals 106A-106L) may be dispersed at various locations throughout the system over time. Each access terminal 106 may communicate with one or more access points 104 on a forward link (FL) and/or a reverse link (RL) at a given moment, depending upon whether the access terminal 106 is active and whether it is in soft handoff, for example. The wireless communication system 100 may provide service over a large geographic region. For example, macro cells 102A-102G may cover a few blocks in a densely populated urban neighborhood or several miles in rural environment.

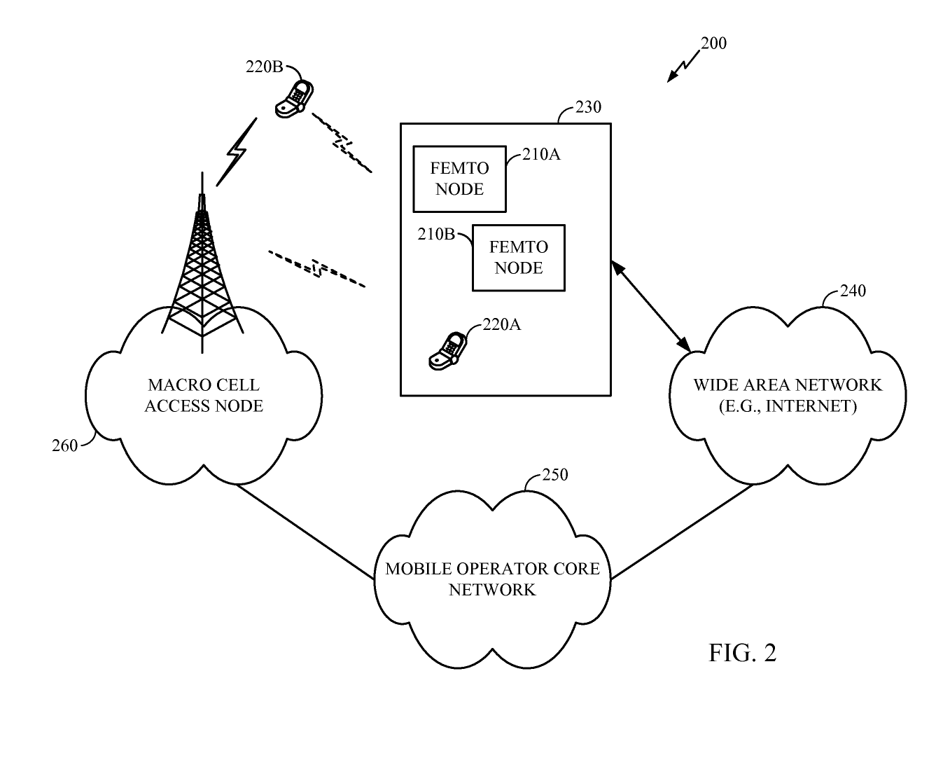

FIG. 2 is a simplified diagram of an example communication system 200 where one or more femto nodes are deployed within a network environment. Specifically, the system 200 includes multiple femto nodes 210 (e.g., femto nodes 210A and 210B) installed in a relatively small scale network environment (e.g., in one or more user residences 230). Each femto node 210 may be coupled to a wide area network 240 (e.g., the Internet) and a mobile operator core network 250 via a DSL router, a cable modem, a wireless link, or other connectivity means (not shown). As will be discussed below, each femto node 210 may be configured to serve associated access terminals 220 (e.g., access terminal 220A) and, optionally, alien access terminals 220 (e.g., access terminal 220B). In other words, access to femto nodes 210 may be restricted whereby a given access terminal 220 may be served by a set of designated (e.g., home) femto node(s) 210 but may not be served by any non-designated femto nodes 210 (e.g., a neighbor's femto node 210).

The owner of a femto node 210 may subscribe to mobile service, such as, for example, 3G mobile service, offered through the mobile operator core network 250. In addition, an access terminal 220 may be capable of operating both in macro environments and in smaller scale (e.g., residential) network environments. In other words, depending on the current location of the access terminal 220, the access terminal 220 may be served by a macro cell access point 260 associated with the mobile operator core network 250 or by any one of a set of femto nodes 210 (e.g., the femto nodes 210A and 210B that reside within a corresponding user residence 230). For example, when a subscriber is outside his home, he is served by a standard macro access point (e.g., access point 260) and when the subscriber is at home, he is served by a femto node (e.g., node 210A). Here, it should be appreciated that a femto node 210 may be backward compatible with existing access terminals 1020.

A femto node 210 may be deployed on a single frequency or, in the alternative, on multiple frequencies. Depending on the particular configuration, the single frequency or one or more of the multiple frequencies may overlap with one or more frequencies used by a macro access point (e.g., access point 260).

An access terminal 220 may be configured to connect to a preferred femto node (e.g., the home femto node of the access terminal 220) whenever such connectivity is possible. For example, whenever the access terminal 220 is within the user's residence 1030, it may be preferred that the access terminal 220 communicate with the home femto node 210.

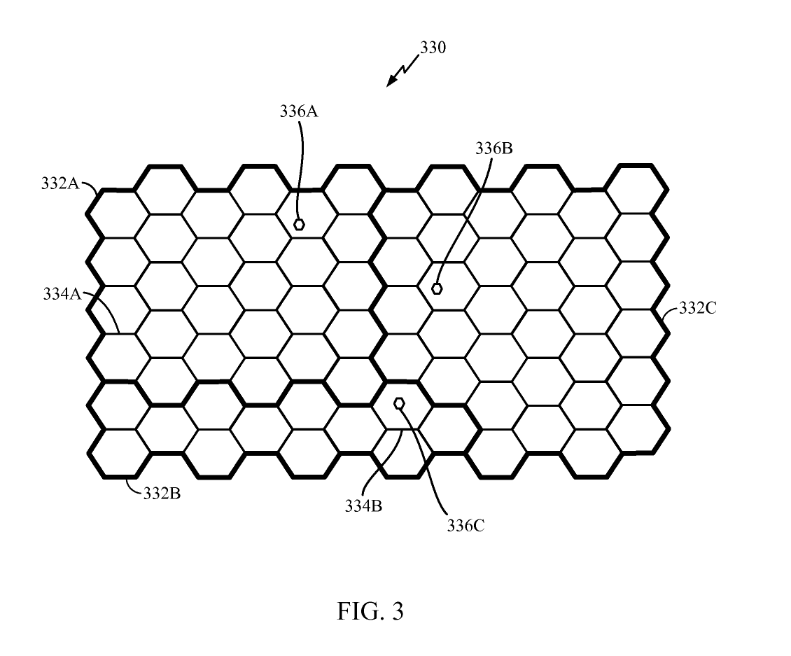

FIG. 3 is a simplified diagram illustrating an example of a coverage map 300 where several tracking areas 332 (or routing areas or location areas) are defined, each of which includes several macro coverage areas 334. Here, areas of coverage associated with tracking areas 332A, 332B, and 332C are delineated by the wide lines and the macro coverage areas 334 are represented by the hexagons. The tracking areas 332 also include femto coverage areas 336. In this example, each of the femto coverage areas 336 (e.g., femto coverage area 336C) is depicted within a macro coverage area 334 (e.g., macro coverage area 334B). It should be appreciated, however, that a femto coverage area 336 may not lie entirely within a macro coverage area 334. In practice, a large number of femto coverage areas 336 may be defined with a given tracking area 332 or macro coverage area 334. Also, one or more pico coverage areas (not shown) may be defined within a given tracking area 332 or macro coverage area 334.

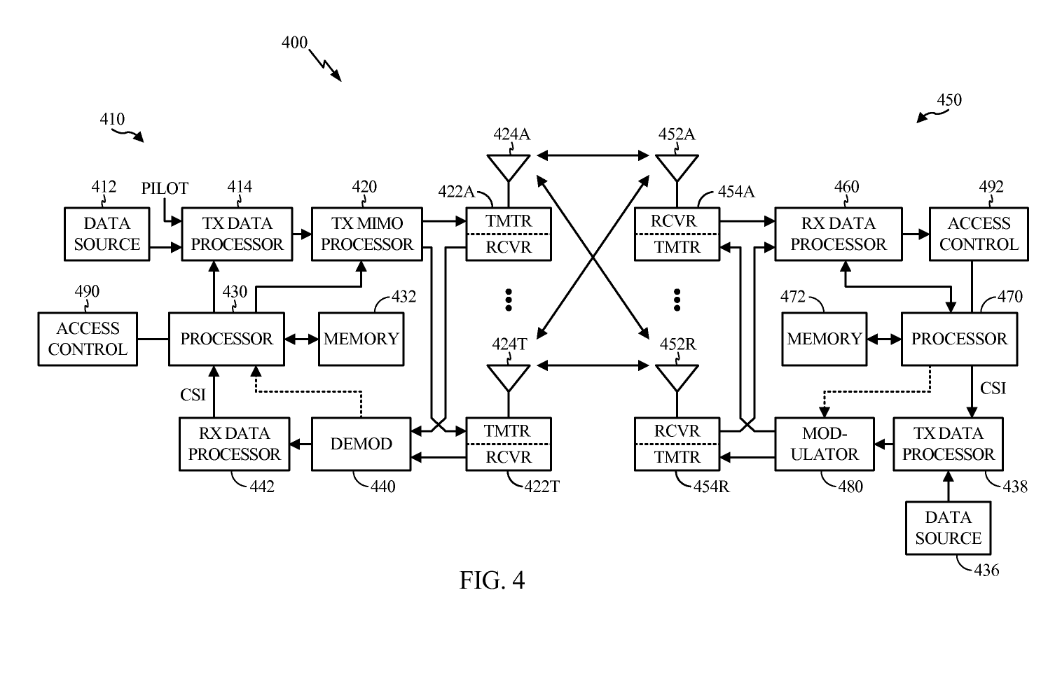

The teachings herein may be incorporated into a node (e.g., a device) employing various components for communicating with at least one other node. FIG. 4 depicts several sample components that may be employed to facilitate communication between nodes. Specifically, FIG. 4 is a simplified block diagram of a first wireless device 410 (e.g., an access point) and a second wireless device 450 (e.g., an access terminal) of a MIMO system 400. At the first device 410, traffic data for a number of data streams is provided from a data source 412 to a transmit (TX) data processor 414.

In some aspects, each data stream is transmitted over a respective transmit antenna. The TX data processor 414 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 430. A data memory 432 may store program code, data, and other information used by the processor 430 or other components of the device 410.

The modulation symbols for all data streams are then provided to a TX MIMO processor 420, which may further process the modulation symbols (e.g., for OFDM). The TX MIMO processor 420 then provides N_{T} modulation symbol streams to N_{T} transceivers (XCVR) 422A through 422T. In some aspects, the TX MIMO processor 420 applies beam-forming weights to the symbols of the data streams and to the antenna from which the symbol is being transmitted.

Each transceiver 422 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 422A through 422T are then transmitted from N_{T} antennas 424A through 424T, respectively.

At the second device 450, the transmitted modulated signals are received by N_{R} antennas 452A through 452R and the received signal from each antenna 452 is provided to a respective transceiver (XCVR) 454A through 454R. Each transceiver 454 conditions (e.g., filters, amplifies, and downconverts) a respective received signal, digitizes the conditioned signal to provide samples, and further processes the samples to provide a corresponding “received” symbol stream.

A receive (RX) data processor 460 then receives and processes the N_{R} received symbol streams from N_{R} transceivers 454 based on a particular receiver processing technique to provide N_{T} “detected” symbol streams. The RX data processor 460 then demodulates, deinterleaves, and decodes each detected symbol stream to recover the traffic data for the data stream. The processing by the RX data processor 460 is complementary to that performed by the TX MIMO processor 420 and the TX data processor 414 at the device 410.

A processor 470 periodically determines which pre-coding matrix to use (discussed below). The processor 470 formulates a reverse link message comprising a matrix index portion and a rank value portion. A data memory 472 may store program code, data, and other information used by the processor 470 or other components of the second device 450.

The reverse link message may comprise various types of information regarding the communication link and/or the received data stream. The reverse link message is then processed by a TX data processor 438, which also receives traffic data for a number of data streams from a data source 436, modulated by a modulator 480, conditioned by the transceivers 454A through 454R, and transmitted back to the device 410.

At the device 410, the modulated signals from the second device 450 are received by the antennas 424, conditioned by the transceivers 422, demodulated by a demodulator (DEMOD) 440, and processed by a RX data processor 442 to extract the reverse link message transmitted by the second device 450. The processor 430 then determines which pre-coding matrix to use for determining the beam-forming weights then processes the extracted message.

FIG. 4 also illustrates that the communication components may include one or more components that perform access control operations as taught herein. For example, an access control component 490 may cooperate with the processor 430 and/or other components of the device 410 to send/receive signals to/from another device (e.g., device 450) as taught herein. Similarly, an access control component 492 may cooperate with the processor 470 and/or other components of the device 450 to send/receive signals to/from another device (e.g., device 410). It should be appreciated that for each device 410 and 450 the functionality of two or more of the described components may be provided by a single component. For example, a single processing component may provide the functionality of the access control component 490 and the processor 430 and a single processing component may provide the functionality of the access control component 492 and the processor 470.

FIG. 5 is a simplified block diagram of several sample aspects of a communication system 500. The system 510 includes a portion of a core network 510, a portion of an evolved UMTS terrestrial radio access network (EUTRAN) 520, and a number of access terminals or UEs 530, 531, 532, 533, 534, 535, 536. Those skilled in the art will appreciate from the disclosure herein that a core network includes a number of features not illustrated in FIG. 5, and for the sake of brevity, only a simplified set of features have been illustrated to discuss aspects of embodiments disclosed herein. To that end, the portion of the core network 510 illustrated in FIG. 5 includes a warning message server 511 and first and second evolved packet core (EPC) nodes 517, 519. While two EPC nodes have been illustrated in FIG. 5, those skilled in the art will appreciate that a wireless network can include any number of EPC nodes and/or sub-networks.

The warning message server 511 includes a cell broadcast center (CBC) 513 and a cell broadcast entity (CBE) 515. For the purposes of this disclosure the CBC 513 and CBE 515 can be considered together as providing warning messages to the first and second evolved packet core nodes 517, 519. The first and second evolved packet core nodes 517, 519 include a number of core LTE network elements including, for example, one or more mobility management entity (MME) nodes. These elements have not been illustrated for the sake of brevity.

The EUTRAN 520 includes a number of access points (eNB) 521, 523, 525, 527, 529. While only five access points have been illustrated in FIG. 5, those skilled in the art will appreciate that a wireless network can include any number of access terminals. With further reference to FIG. 5, the first EPC 517 is in communication with the first and second eNBs 521, 523, and the second EPC 519 is in communication with the third, fourth and fifth eNBs 525, 527, 529. The first eNB 521 provides communication access for the first and second access terminals (UEs) 530, 531. The second eNB 523 provide communication access for the third UE 532. The third eNB 525 provide communication access for the fourth UE 533. The fifth eNB 529 provide communication access for the fifth, sixth and seventh UEs 534, 535, 536. Those skilled in the art will appreciate that the arrangement of elements shown in FIG. 5 is merely one simplified example of a wireless network, and that various other arrangements are possible.

In operation, there are situations in which it may be desirable to broadcast emergency services messages to all or a subset of UEs. The previously available Earthquake and Tsunami warning service (ETWS) provided by 3GPP technical specification 22.168 provides a system in which a UE or an access terminal is configured to only receive a single warning message and purposefully ignore any other warning message subsequently transmitted by an access point e.g. eNB 521 in FIG. 5). Specifically, a UE configured to support ETWS operation will stop reception of system information block type 11 (SIB11) once the UE has received all segments of a warning message.

A public warning system (PWS) described in 3GPP Release-9 (TS 22.268 and TR 22.968) is a generalization of the ETWS. Among other features, PWS aims to broadcast multiple warning messages to multiple UEs. However, PWS does not provide a system and/or method of operation to enable a UE to determine how many warning messages are transmitted by the serving access point and subsequently takes steps to receive multiple warning messages. Without such a system or method, there is no way to determine whether or not a UE should maintain open reception on the channel on which warning messages are transmitted. If a UE does not maintain reception for a long enough period, the UE may not receive all of the transmitting warning messages. Consequently, valuable and possibly life saving information will not be provided to the end user. On the other hand, if the UE maintains open reception for too long, the power consumption required to maintain open reception will deplete the battery unnecessarily.

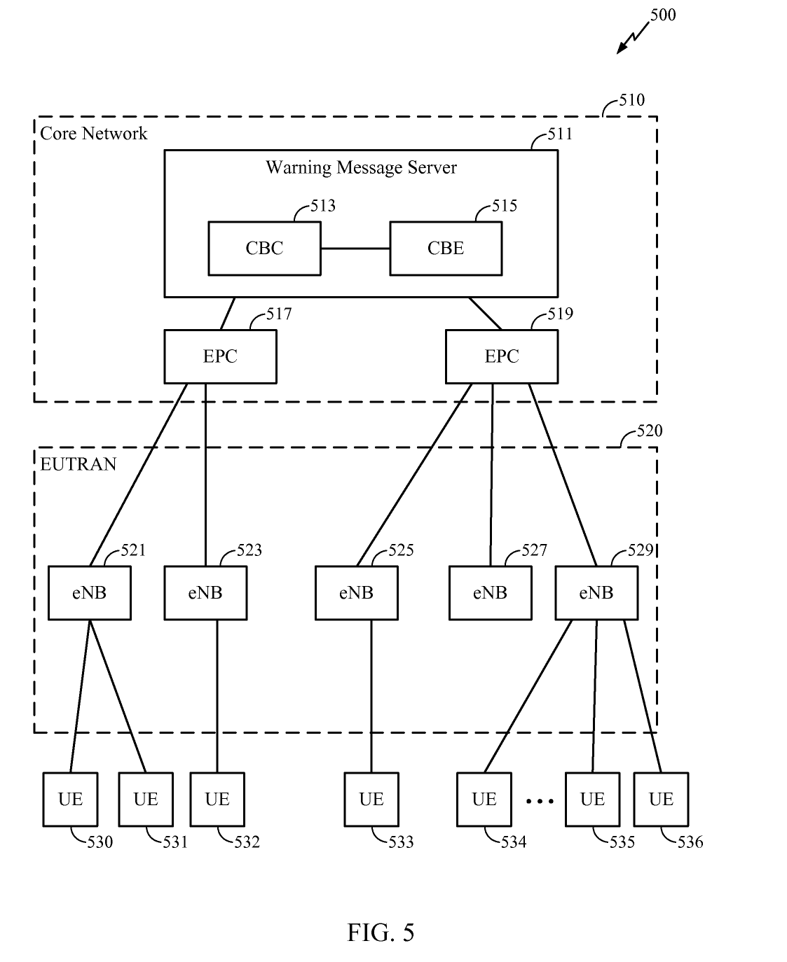

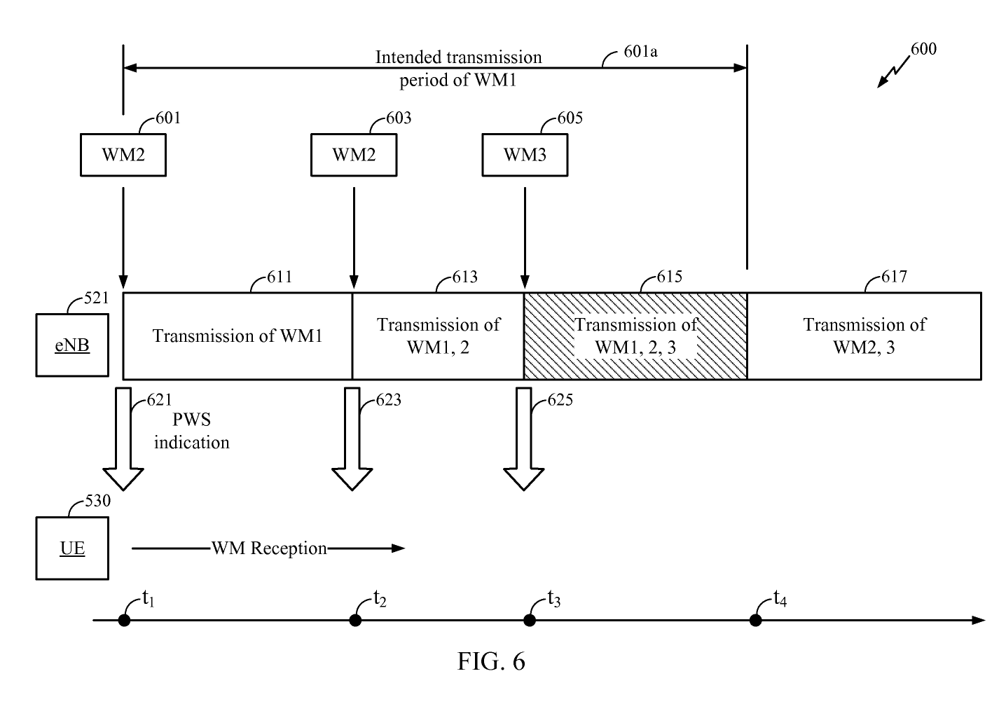

FIG. 6 is a signaling diagram 600 illustrating communication of multiple warning messages 601, 603, 605 within the system 500 of FIG. 5, which illustrates the aforementioned problems with ETWS and PWS. At time t₁, the eNB 521 receives the first warning message 601 from the EPC 517 (not shown). In response to receiving the first warning message 601, the eNB 521 broadcasts a first paging indicator 621 indicating that a new warning message is available for reception. The eNB 521 also begins the transmission of the first segment 611 of the first warning message to the first UE 530 and the second UE 531 (not shown) on a broadcast channel, as indicated by 611. The eNB 521 may also transmit subsequent segments of the first warning message. Moreover, the segments of any particular warning message may be repeated at a predefined periodicity.

At time t₂, the eNB 521 receives the second warning message 603 from the EPC 517 (not shown). In response to receiving the second warning message 603, the eNB 521 broadcasts a second paging indicator 623 indicating that a new warning message is available for reception. The eNB 521 also begins the transmission of the first segment of the second warning message 603 to the first UE 530 and the second UE 531 (not shown) on a broadcast channel in parallel with the second segment of the first warning message 601, as indicated by 613. Those skilled in the art will appreciate that, at time t₂, it is not necessarily the second segment of the first warning message 601 that is transmitted by the eNB 521. Rather it may merely be another segment of the first warning message 601.

At time t₃, the eNB 521 receives the third warning message 605 from the EPC 517 (not shown). In response to receiving the third warning message 603, the eNB 521 broadcasts a third paging indicator 625 indicating that a new warning message is available for reception. The eNB 521 also begins the transmission of the first segment of the third warning message 605 to the first UE 530 and the second UE 531 (not shown) on a broadcast channel in parallel with the third segment of the first warning message 601 and the second segment of the second warning message 603, as indicated by 615.

In accordance with the ETWS, the first UE 530 will close or halt reception on the broadcast channel when all of the segments of the first warning message 601 are fully received. In the example shown in FIG. 6, the first UE 530 will closes reception on the broadcast channel at time t₄, when the end of the third and final segment of the first warning message 601 is received. This will occur, because according to the ETWS, UEs are programmed to assume that there is a single warning message that is valid at a given time. Subsequently, the remaining portions of the second and third warning messages and repeated segments of the first warning message will not be received by the first UE 530 if it is operating according to ETWS.

Systems, methods and apparatus described herein include features that enable the reception of multiple warning messages. In one embodiment, the access point transmits a list of warning messages currently being transmitted. Using the list a UE is able to determine whether all of the currently available warning messages have been received, and in turn, whether to maintain open reception in order to enable reception of the warning messages on the list that have not been fully received. In another embodiment, the access point transmits an indicator of a counter value. Using the indicator of the counter value, a UE is able to decipher how many warning messages are being transmitted. In turn, by comparing the number of warning messages currently being transmitted to the number of warning messages that the UE has received, the UE is able to determine whether or not to maintain open reception in order to enable reception of the warning messages on the list that have not been fully received. In another embodiment, an access point transmits an indicator that the number of available warning messages has changed. In turn, a UE is able to determine whether or not to check for a new list or indicator of a counter value. In yet another embodiment, an access point transmits an indicator of an approximated duration of time during which a UE is suggested to maintain open reception on the channel on which warning messages are transmitted. This timer value may be used to prevent the UE from maintaining open reception erroneously for too long.

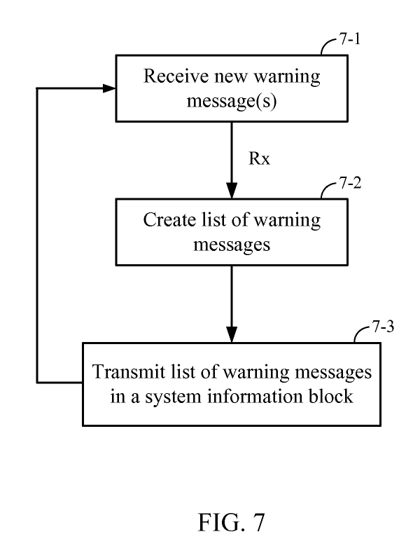

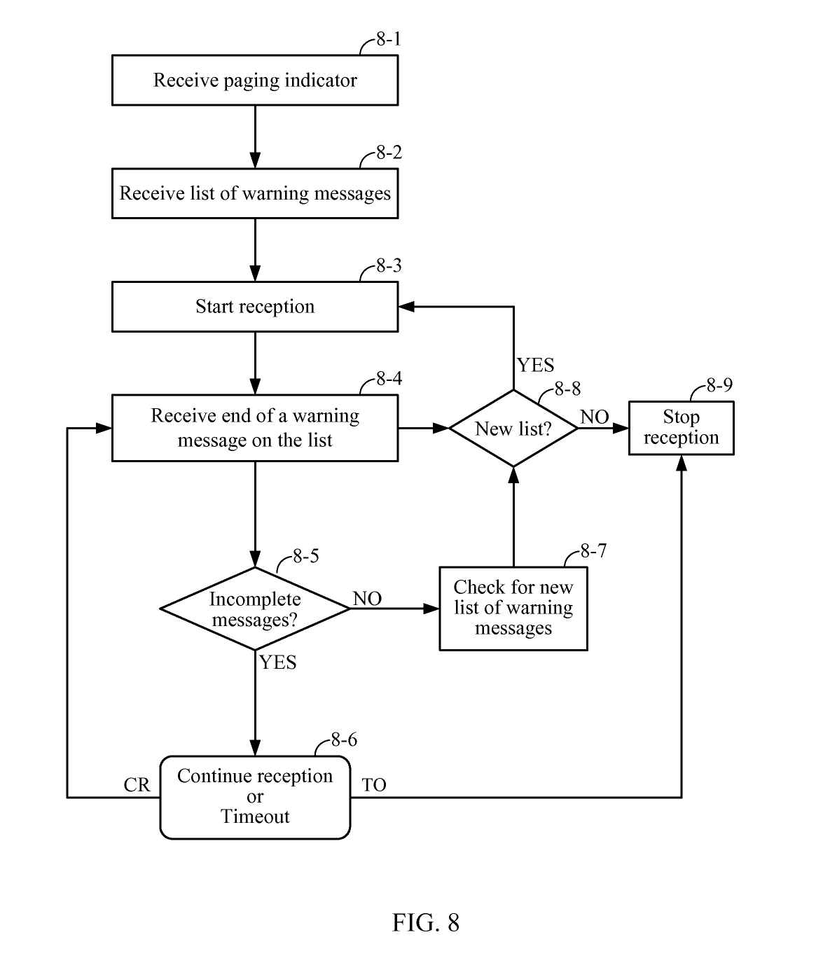

FIG. 7 is a flowchart illustrating a first method of enabling reception of multiple warning messages. In one embodiment, the first method is performed by an access point to enable one or more access terminals to receive multiple warning messages. According to aspects of the first method, the access point transmits a list of warning message identifiers currently being transmitted, scheduled to be transmitted and/or available for reception. In a complementary method, using the list, a UE is able to determine whether all of the currently available warning messages have been received, and in turn, whether to maintain open reception in order to enable reception of the warning messages on the list that have not been fully received. A method for utilizing the list, which can be performed by an access terminal is described in detail below with reference to FIG. 8.

As represented by block 7-1, the method includes an access point receiving one or more new warning messages. Upon receiving the one or more new warning messages (Rx path from 7-1), as represented by block 7-2, the method includes creating a list of warning message identifiers. The list preferably includes a respective warning message identifier for each warning message received and scheduled for transmission by the access point. As represented by block 7-3, the method includes transmitting the list of warning message identifiers. In one embodiment, the list is transmitted on a paging channel. However, those skilled in the art will appreciate that the list may be additionally and/or alternatively transmitted on one or more other channels defined within a wireless communication system. In another embodiment, the list is transmitted in a system information block.

FIG. 8 is a flowchart illustrating a second method of enabling reception of multiple warning messages. As noted above, in one embodiment, the second method is performed by an access terminal (e.g. a UE) attempting to detect and receive multiple warning messages transmitted by an access point. As represented by block 8-1, the method includes receiving a paging indicator alerting the access terminal that a new list of warning message identifiers is available. As represented by block 8-2, the method includes receiving a list of warning message identifiers. As noted above with reference to FIG. 7, the list preferably includes a respective warning message identifier for each warning message received and scheduled for transmission by the access point.

As represented by block 8-3, the method includes starting reception on the channel over which the warning messages are transmitted. As represented by block 8-4, the method includes fully receiving at least one warning message. In one embodiment, the warning messages are divided into and transmitted in segments that need to be recombined by a receiving device. Additionally and/or alternatively, in other embodiments, warning messages are transmitted without being divided into segments.

As represented by block 8-5, the method includes determining whether or not there are other warning messages that have not yet been fully received and/or not received at all. To that end, the method includes comparing the fully received warning message(s) to the list of warning message identifiers to determine whether or not all the warning messages listed by the respective identifiers have been fully received.

If there are warning messages that have not been fully received (yes path from 8-5), as represented by block 8-6, the method includes continuing open reception on the channel over which warning messages are transmitted within the wireless system until a local timer runs out. If the timer runs out (TO path from 8-6) before another warning message is fully received, as represented by clock 8-9, the method includes stopping or closing reception on the channel to reduce the power drawn by the receiver. In one embodiment, the timer is initially set using the delivery delay timer value received from the access point.

Referring again to block 8-5, if there are no more warning messages that can be received (no path from 8-5), as represented by block 8-7, the method includes checking for a new list of warning messages. In one embodiment, the access terminal checks for a new list of warning messages by parsing a system information broadcast message or the like. As represented by block 8-8, the method includes determining whether or not there is a new list. In on embodiment, determining whether or not there is a new list includes comparing the previously received and utilized list with a list retrieved by parsing a system information broadcast message or the like. If a new list has not been received (no path from 8-8), as represented by block 8-9, the method includes stopping or closing reception on the channel to reduce the power drawn by the receiver. On the other hand, if a new list has been received (yes path from 8-8), the method includes returning to the portion of the method represented by block 8-3, where open reception is either restarted or maintained.

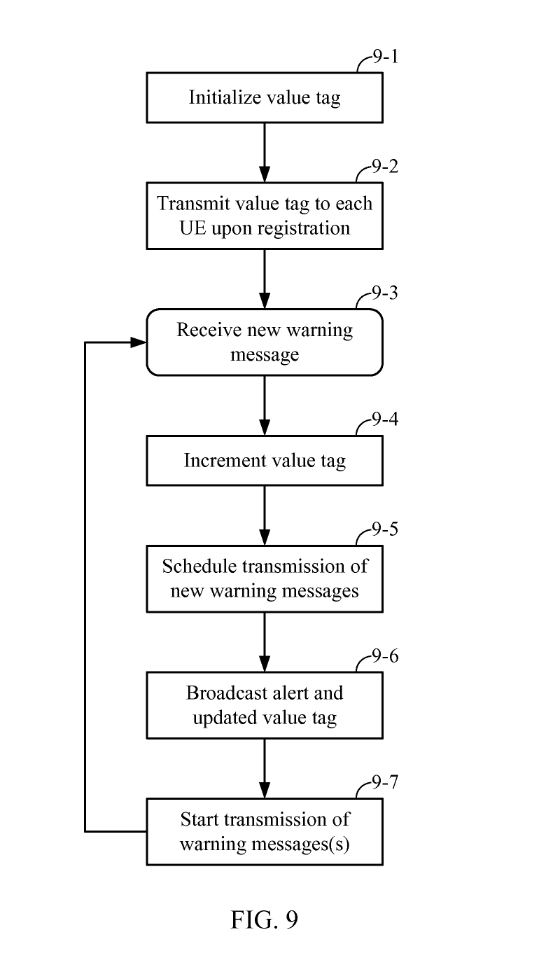

FIG. 9 is a flowchart illustrating a third method of enabling reception of multiple warning messages. In one embodiment, the third method is performed by an access point to enable one or more access terminals to receive multiple warning messages. According to aspects of the third method, the access point transmits an indicator of a counter value. In a complementary method, using at least the indicator of the counter value, an access terminal is able to decipher how many warning messages are being currently transmitted or the number of transmitted warning messages has changed. In one embodiment, the indicator of the counter value is the counter value, while in another embodiment, the indicator of the counter value is a reference to the counter value. By comparing the number of warning messages currently being transmitted to the number of warning messages that the access terminal has received, the access terminal is able to determine whether or not to maintain open reception in order to enable reception of the warning messages on the list that have not been fully received.

As represented by block 9-1, the method includes initializing a counter, referred to hereinafter as a value tag. The value tag does not have to be initialized to zero, and can be initialized to any number. In one embodiment, one or more increments of the value tag are used by the access terminals to determine the number of warning messages that an access point is currently transmitting or is scheduled to transmit.

As represented by block 9-2, the method includes transmitting the value tag to an access terminal when that access terminal initializes and/or reestablishes a communication link to the access point. As represented by block 9-3, the method includes an access point receiving one or more new warning messages from the core network and/or a warning message server. As represented by block 9-4, the method includes incrementing the value tag (i.e. a counter) to reflect the number of received warning messages. For example, each increment in the value tag represents a respective warning message. In another example, each increment in the value tag can represent one or more warning messages. In another example, the current value of the value tag represents the number of warning messages. In yet another example, the value tag is a reference and/or pointer to the number of warning messages.

As represented by block 9-5, the method includes scheduling the transmission of the newly received warning messages. As represented by block 9-6, the method includes broadcasting an alert message and the updated value tag. In one embodiment, the alert message is a paging message. Additionally and/or alternatively, the updated value tag is provided along with the paging message or in a system information broadcast message. Additionally and/or alternatively, an indicator of the value tag is transmitted instead of the actual value tag. An indicator of the value tag includes a reference and a pointer to the value tag. As represented by block 9-7, the method includes starting the transmission of the warning messages. Those skilled in the art will appreciate that the transmission of the warning messages can be before, during or after the transmission of alert message and the value tag. Following block 9-7, the method includes returning to block 9-3 to await new warning messages.

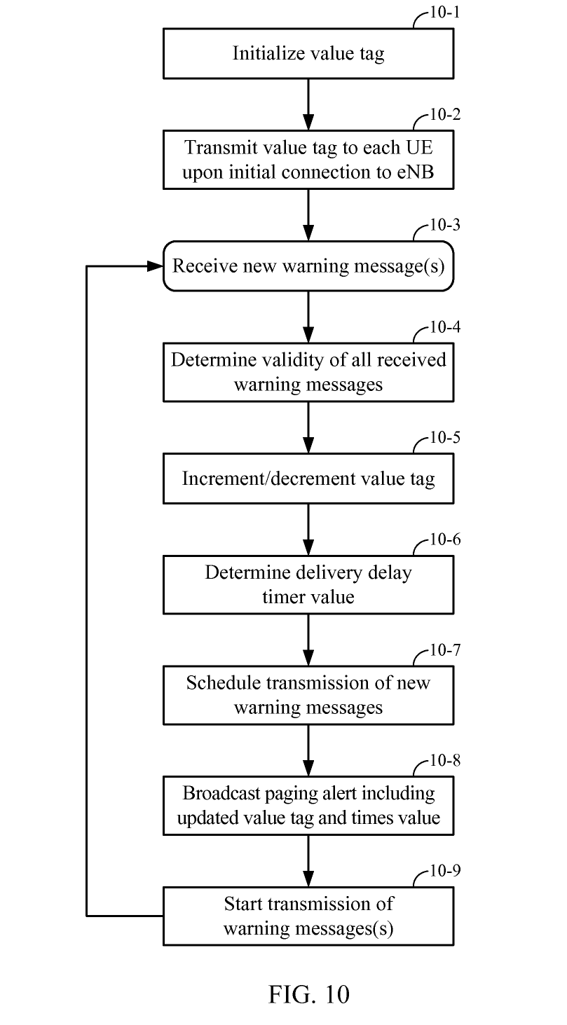

FIG. 10 is a flowchart illustrating a fourth method of enabling reception of multiple warning messages. In one embodiment, the fourth method is performed by an access point to enable one or more access terminals to receive multiple warning messages in a manner similar to and adapted from the third method described above. As represented by block 10-1, the method includes initializing a counter, referred to hereinafter as a value tag. The value tag does not have to be initialized to zero, and can be initialized to any number. In one embodiment, one or more increments of the value tag are used by the access terminals to determine the number of warning messages that an access point is currently transmitted or is scheduled to transmit.

As represented by block 10-2, the method includes transmitting the value tag to an access terminal when that access terminal initializes and/or reestablishes a communication link to the access point. As represented by block 10-3, the method includes an access point receiving one or more new warning messages from the core network and/or a warning message server. As represented by block 10-4, the method includes determining the validity of the received warning messages. A warning message, for example, may be invalid because the elapsed time since it was received indicates that the warning message is no longer applicable. In another example, a warning message may be determined as being invalid because the access point has received contradictory information. In turn, in one embodiment, invalid warning messages are deleted by the access point so as to not cause erroneous alarm.

As represented by block 10-5, the method includes incrementing and/or decrementing the value tag (i.e. a counter) to reflect the number of received warning messages determined to be valid. As represented by block 10-6, the method includes determining a delivery delay timer value. In one embodiment, the delivery delay timer value represents the approximate amount of time that it will take the access point to transmit all of the valid warning messages. Typically, the delay scales as a function of the number of warning messages scheduled for transmission. In one embodiment, it is preferable to have the access point determine the delivery delay timer value because the access point schedules the transmission of the warning messages, and in turn, is likely better able to approximate delays based on the scheduling.

As represented by block 10-7, the method includes scheduling the transmission of the newly received warning messages. As represented by block 10-8, the method includes broadcasting an alert message, the updated value tag, and the delivery delay timer value. In one embodiment, the alert message is a paging message. Additionally and/or alternatively, the delivery delay timer value is provided along with the paging message or in a system information broadcast message. Additionally and/or alternatively, an indicator of the delivery delay timer value is transmitted instead of the delivery delay timer value. An indicator of the delivery delay timer value includes a reference and a pointer to the delivery delay timer value. As represented by block 10-9, the method includes starting the transmission of the warning messages. Those skilled in the art will appreciate that the transmission of the warning messages can be before, during or after the transmission of alert message and the value tag. Following block 10-9, the method includes returning to block 10-3 to await new warning messages.

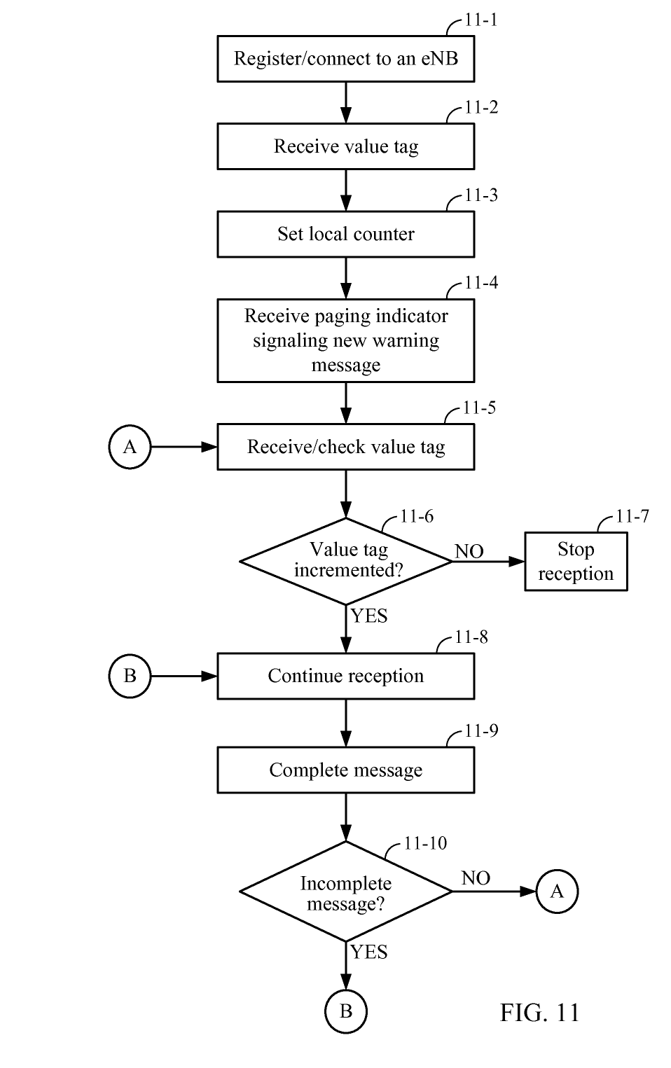

FIG. 11 is a flowchart illustrating a fifth method of enabling reception of multiple warning messages. As noted above, in one embodiment, the fifth method is performed by an access terminal attempting to detect and receive multiple warning messages transmitted by an access point. The fifth method is an example of a method complementary to the third method described above. As represented by block 11-1, the method includes the access terminal registering with or connected to an access point. As represented by block 11-2, the method includes receiving a value tag or an indicator of the value tag transmitted by an access point or another network element. As represented by block 11-3, the method includes initially setting a local counter in response to receiving the value tag or the indicator of the value tag.

As represented by block 11-4, the method includes receiving a paging indicator signaling the access terminal to the availability of at least one new warning message. As represented by block 11-5, the method includes receiving and checking the new value tag.

As represented by block 11-6, the method includes determining whether or not the value tag has been incremented by comparing the newly received value tag with the previously received value tag. If the value tag has not been incremented (no path from 11-6), as represented by block 11-7, the method includes stopping and/or closing reception on the channel over which warning messages are transmitted within the wireless system. On the other hand, if the value tag has been incremented (yes path from 11-7), as represented by block 11-8, the method includes continuing open reception on the channel over which warning messages are transmitted within the wireless system. As represented by block 11-9, the method includes confirming that at least one warning message has been fully received.

As represented by block 11-10, the method includes determining whether or not there are warning messages that have not been fully received. In one embodiment, determining that there are warning messages that have not been fully received includes comparing the number of warning messages available for reception, as indicated by the value tag, to the number of warning messages that have been fully received. If there are more warning messages available (yes path from 11-10), the method includes returning to block 11-8 so that open reception is maintained. On the other hand, if it is determined that there are no more warning messages available for reception (no path from 11-10), the method includes stopping open reception as represented by block 11-7.

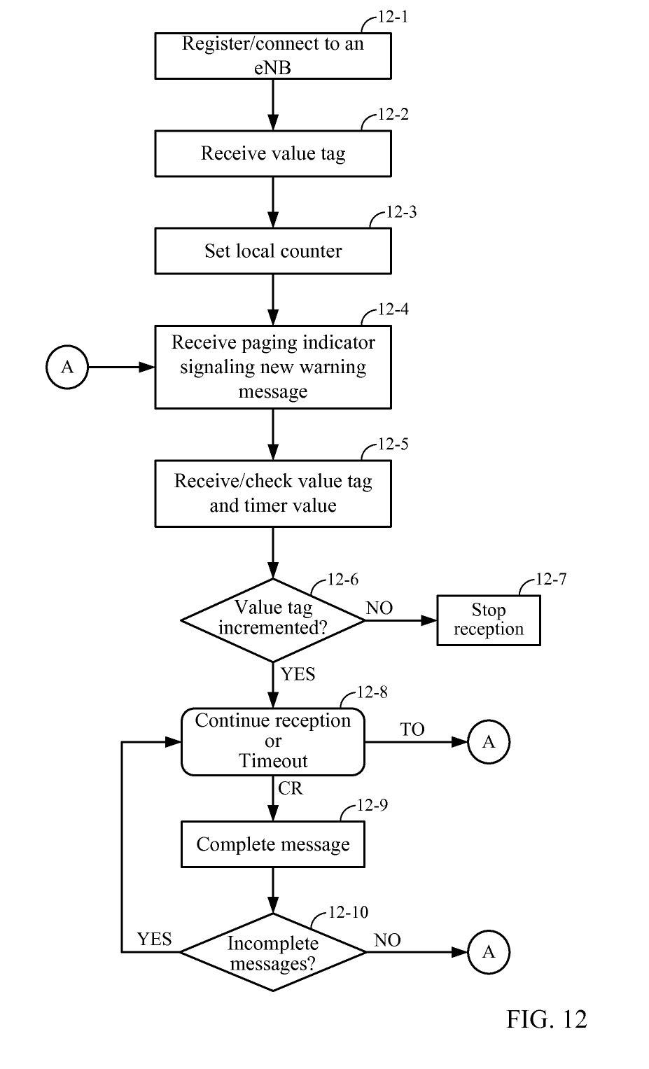

FIG. 12 is a flowchart illustrating a sixth method of enabling reception of multiple warning messages. As noted above, in one embodiment, the sixth method is performed by an access terminal attempting to detect and receive multiple warning messages transmitted by an access point. The sixth method is an example of a method complementary to the fourth method described above. As represented by block 121-1, the method includes the access terminal registering with or connected to an access point. As represented by block 12-2, the method includes receiving a value tag or an indicator of the value tag transmitted by an access point or another network element. As represented by block 12-3, the method includes initially setting a local counter in response to receiving the value tag or the indicator of the value tag.

As represented by block 12-4, the method includes receiving a paging indicator signaling the access terminal to the availability of at least one new warning message. As represented by block 12-5, the method includes receiving and checking the new value tag and a delivery delay timer value.

As represented by block 12-6, the method includes determining whether or not the value tag has been incremented by comparing the newly received value tag with the previously received value tag. If the value tag has not been incremented (no path from 12-6), as represented by block 12-7, the method includes stopping and/or closing reception on the channel over which warning messages are transmitted within the wireless system. On the other hand, if the value tag has been incremented (yes path from 12-7), as represented by block 12-8, the method includes continuing open reception on the channel over which warning messages are transmitted within the wireless system until a timer crosses a threshold or reaches a zero value. In one embodiment, the timer is initially set using the delivery delay timer value received from the access point. If the timer runs down before a warning message is fully received (TO path from 12-8), the method includes returning to block 12-4. On the other hand, if a warning message is fully received before the timer runs down (CR path from 12-8), as represented by block 12-9, the method includes confirming that at least one warning message has been fully received.

As represented by block 12-10, the method includes determining whether or not there are warning messages that have not been fully received. In one embodiment, determining that there are warning messages that have not been fully received includes comparing the number of warning messages available for reception, as indicated by the value tag, to the number of warning messages that have been fully received. If there are more warning messages available (yes path from 12-10), the method includes returning to block 12-8 so that open reception is maintained. On the other hand, if it is determined that there are no more warning messages available for reception (no path from 12-10), the method includes returning to block 12-4.

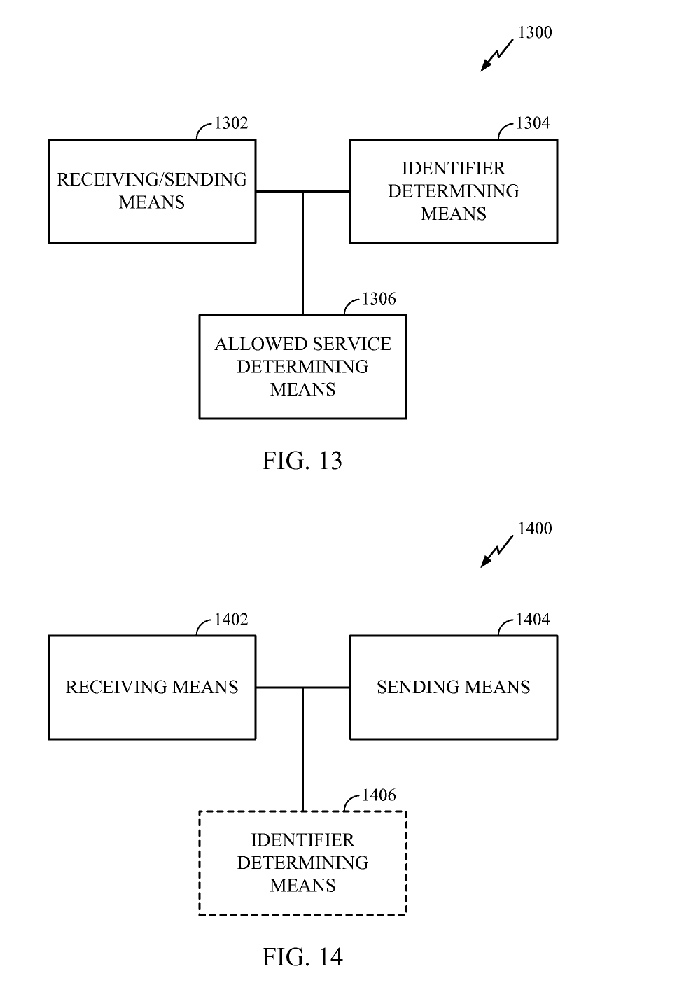

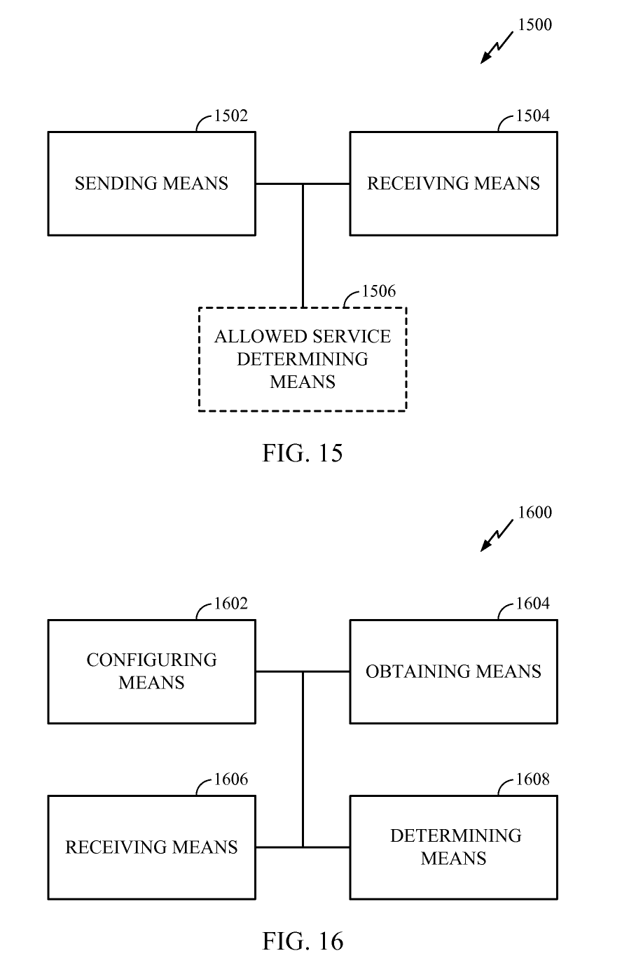

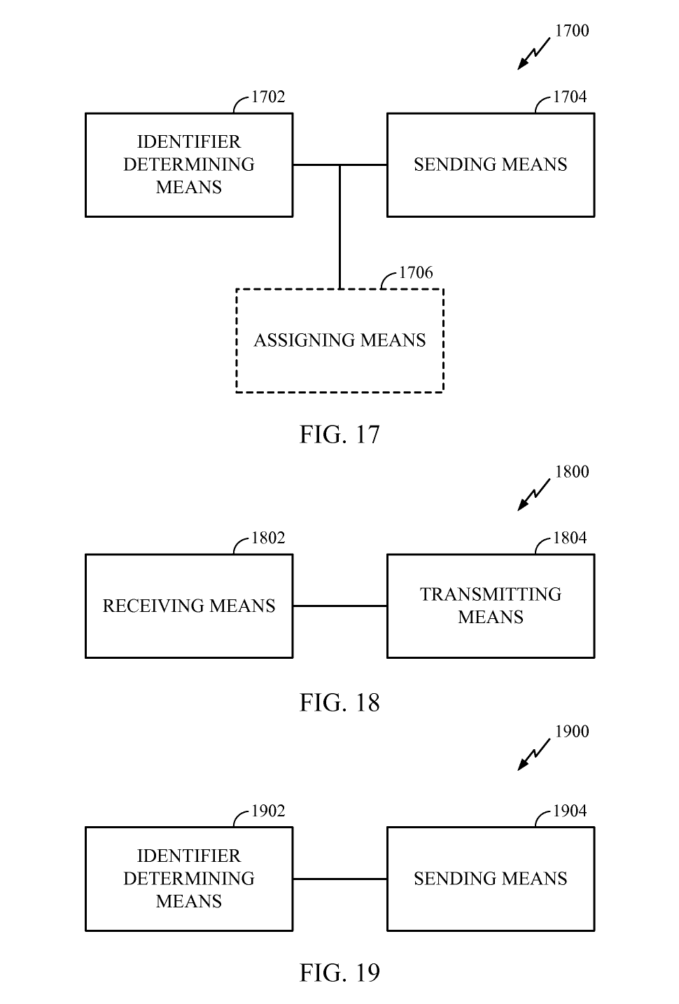

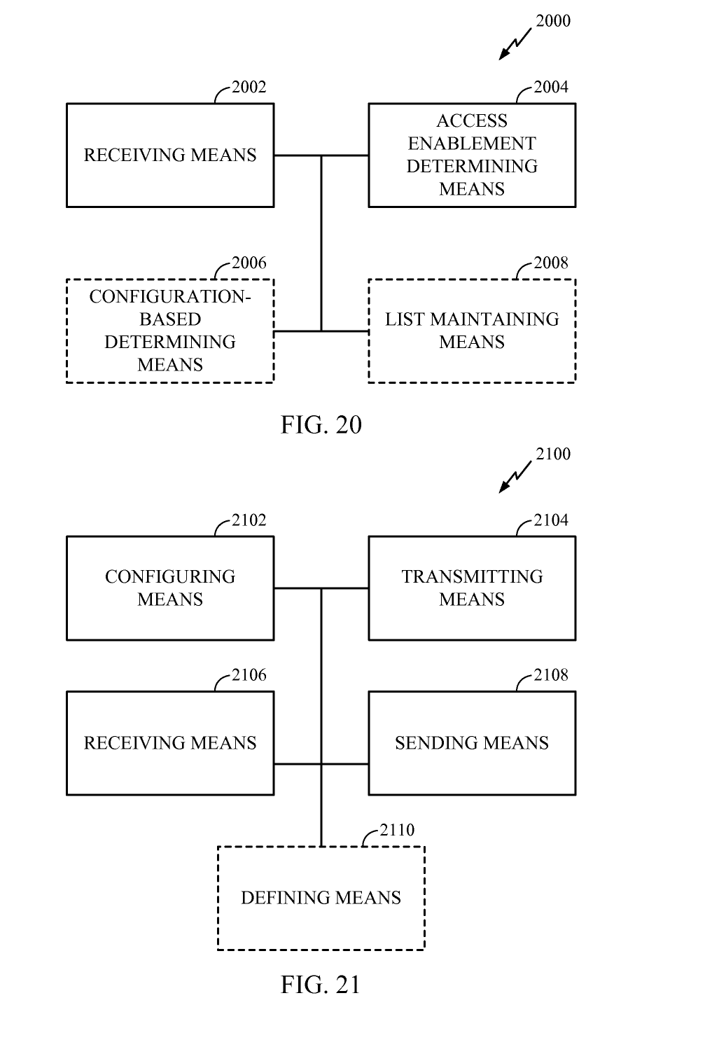

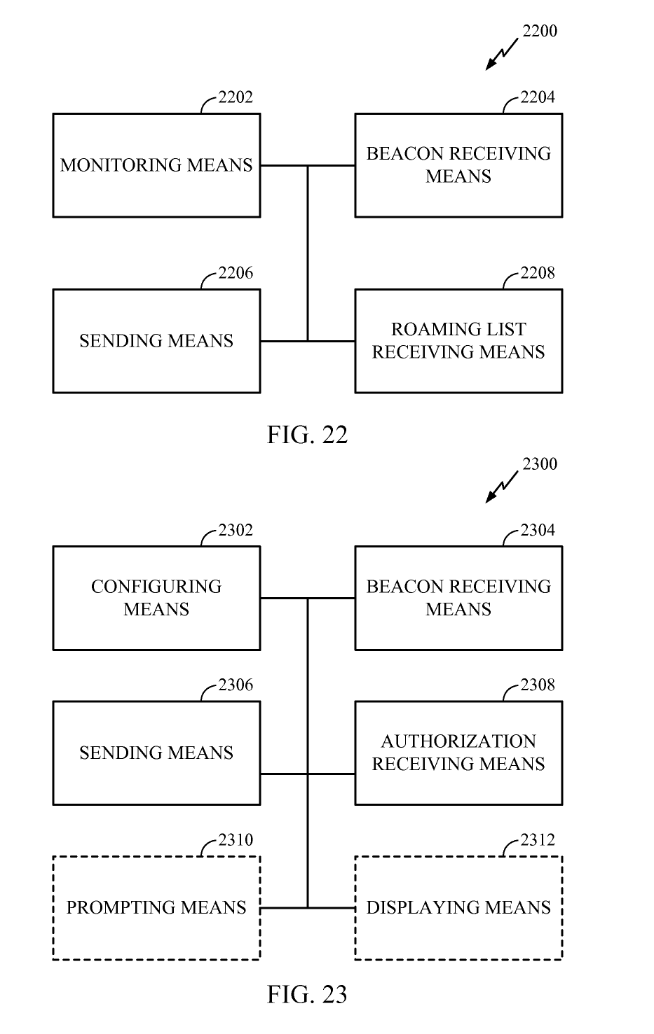

The components described herein may be implemented in a variety of ways. Referring to FIGS. 13-23, apparatuses 1300, 1400, 1500, 1600, 1700, 1800, 1900, 2000, 2100, 2200, and 2300 are represented as a series of interrelated functional blocks. In some aspects the functionality of these blocks may be implemented as a processing system including one or more processor components. In some aspects the functionality of these blocks may be implemented using, for example, at least a portion of one or more integrated circuits (e.g., an ASIC). As discussed herein, an integrated circuit may include a processor, software, other related components, or some combination thereof. The functionality of these blocks also may be implemented in some other manner as taught herein. In some aspects one or more of the dashed blocks in FIGS. 13-23 are optional.

The apparatuses 1300, 1400, 1500, 1600, 1700, 1800, 1900, 2000, 2100, 2200, and 2300 may include one or more modules that may perform one or more of the functions described above with regard to various figures. For example, a receiving/sending means 1302 may correspond to, for example, a communication controller as discussed herein. An identifier determining means 1304 may correspond to, for example, an access controller as discussed herein. An allowed service determining means 1306 may correspond to, for example, an access controller as discussed herein. A receiving means 1402 may correspond to, for example, a communication controller as discussed herein. A sending means 1404 may correspond to, for example, an access controller as discussed herein. An identifier determining means 1406 may correspond to, for example, an access controller as discussed herein. A sending means 1502 may correspond to, for example, an access controller as discussed herein. A receiving means 1504 may correspond to, for example, a communication controller as discussed herein. An allowed service determining means 1506 may correspond to, for example, an access controller as discussed herein. A configuring means 1602 may correspond to, for example, a provisioning controller as discussed herein. An obtaining means 1604 may correspond to, for example, an access controller as discussed herein. A receiving means 1606 may correspond to, for example, a communication controller as discussed herein. A determining means 1608 may correspond to, for example, an access controller as discussed herein. An identifier determining means 1702 may correspond to, for example, a provisioning controller as discussed herein. A sending means 1704 may correspond to, for example, a communication controller as discussed herein. An assigning means 1706 may correspond to, for example, a provisioning controller as discussed herein. A receiving means 1802 may correspond to, for example, a provisioning controller as discussed herein. A transmitting means 1804 may correspond to, for example, a communication controller as discussed herein. An identifier determining means 1902 may correspond to, for example, a provisioning controller as discussed herein. A sending means 1904 may correspond to, for example, a communication controller as discussed herein. A receiving means 2002 may correspond to, for example, a communication controller as discussed herein. An access enablement determining means 2004 may correspond to, for example, an access controller as discussed herein. A configuration-based determining means 2006 may correspond to, for example, an access controller as discussed herein. A list maintaining means 2008 may correspond to, for example, an access controller as discussed herein. A configuring means 2102 may correspond to, for example, a provisioning controller as discussed herein. A transmitting means 2104 may correspond to, for example, a communication controller as discussed herein. A receiving means 2106 may correspond to, for example, a communication controller as discussed herein. A sending means 2108 may correspond to, for example, a provisioning controller as discussed herein. A defining means 2110 may correspond to, for example, a provisioning controller as discussed herein. A monitoring means 2202 may correspond to, for example, a receiver as discussed herein. A beacon receiving means 2204 may correspond to, for example, a receiver as discussed herein. A sending means 2206 may correspond to, for example, a communication controller as discussed herein. A roaming list receiving means 2208 may correspond to, for example, a provisioning controller as discussed herein. A configuring means 2302 may correspond to, for example, a provisioning controller as discussed herein. A beacon receiving means 2304 may correspond to, for example, a receiver as discussed herein. A sending means 2306 may correspond to, for example, a communication controller as discussed herein. An authorization receiving means 2308 may correspond to, for example, an access controller as discussed herein. A prompting means 2310 may correspond to, for example, an access controller as discussed herein. A displaying means 2312 may correspond to, for example, an access controller as discussed herein.

Moreover, the teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In summary, it should be appreciated that a computer-readable medium may be implemented in any suitable computer-program product.

The above description is provided to enable any person skilled in the art to make or use embodiments within the scope of the appended claims. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method comprising:
receiving one or more warning messages;
generating a first indicator of the number of warning messages that an access point will broadcast to access terminals; and
transmitting the first indicator to one or more access terminals in response to receiving the one or more and subsequently received warning messages.

2. The method of claim 1, further comprising transmitting an indication of a change of the first indicator in response to a respective change of the first indicator.

3. The method of claim 1, wherein the first indicator is a list of warning message identifiers, and wherein the list includes a respective identifier for each of the one or more received warning messages.

4. The method of claim 3, further comprising:
receiving one or more additional warning messages;
updating the list to include a respective identifier for each of the one or more additional warning messages;
transmitting a message to indicate that the list has been updated; and
transmitting the updated list and the one or more received warning messages to one or more access terminals.

5. The method of claim 3, further comprising:
determining whether or not each of the received warning messages continues to be valid;
deleting invalid warning message identifiers from the list;
transmitting a message to indicate that the list has been updated; and
transmitting the updated list and the one or more valid warning messages to one or more access terminals.

6. The method of claim 1, further comprising:
determining a timer value, wherein the timer value is determined at least partially as a function of a delivery delay associated with the received warning messages; and
transmitting an indicator of the timer value to one or more access terminals.

7. The method of claim 1, wherein the first indicator is a counter value, and the method further comprises:
scheduling the transmission of the one or more received warning messages;
changing the counter value in response to receiving the one or more warning messages so that the counter value provides an indication of the number of warning messages scheduled for transmission; and
transmitting a second indicator to one or more access terminals, the second indicator providing an indication of the counter value.

8. The method of claim 7, further comprising:
determining whether or not each of the received warning messages is valid; and
incrementing the counter value as a function of the number of the received warning messages determined to be valid.

9. The method of claim 7, further comprising:
determining whether or not each of the received warning messages continues to be valid; and
wherein changing the counter value includes at least one of incrementing the counter value as a function of the number of received warning messages determined to be valid and decrementing the counter value as a function of the number of the received warning messages determined to be invalid.

10. The method of claim 7, further comprising broadcasting an alert message including the counter value.

11. The method of claim 10, wherein the alert message is a paging message.

12. The method of claim 7, further comprising:
determining a timer value, wherein the timer value is determined at least partially as a function of a delivery delay associated with the one or more received warning message; and
transmitting a third indicator to one or more access terminals, the third indicator providing an indication of the timer value.

13. The method of claim 12, wherein the third indicator of the timer value is transmitted within a system information broadcast message.

14. A method comprising:
receiving a first indicator of the number of warning messages that an access point will broadcast to access terminals; and
maintaining open reception on the wireless channel until at least one of:
all the warning messages available as indicated by the first indicator are received and the access point instructs the access terminal to stop reception.

15. The method of claim 14, further comprising receiving an indication of a change of the first indicator in response to a respective change of the first indicator.

16. The method of claim 14, wherein the first indicator is a list of warning messages with respective identifiers, the method further comprising:
maintaining open reception on a wireless channel until at least one warning message with a respective identifier on the list has been fully received;
determining whether or not other warning messages with respective identifiers on the list have been fully received; and
maintaining open reception on the wireless channel when there are warning messages with respective identifiers on the list that have not be fully received.

17. The method of claim 16, further comprising:
determining whether or not a new list is available when there are no more warning messages with respective identifiers on the list that have not be fully received; and
at least one of ceasing reception on the wireless channel when it is determined that there is not a new list available, and receiving the new list when it is determined that there is a new list available.

18. The method of claim 17, wherein a new list includes at least one of a list including new entries and a list including at least one warning message identifier from the previous list and at least one new warning message identifier.

19. The method of claim 16, further comprising:
receiving a second indicator of a timer value;
setting a local timer according to the second indicator of the timer value; and
ceasing reception on the wireless channel when the timer crosses a threshold.

20. The method of claim 19, wherein reception is ceased even if there are warning messages with respective identifiers on the list that have not been fully received.

21. The method of claim 14, wherein the first indicator is an indicator of a counter value maintained at the access point, the method further comprising:
receiving a subsequent counter value;
determining a number of warning messages available for reception by comparing the subsequent counter value to the initial counter value;
maintaining open reception on a wireless channel until at least one warning message has been fully received;
determining whether or not other warning messages available for reception have been fully received; and
maintaining open reception on the wireless channel when there are warning messages have not be fully received.

22. The method of claim 21, wherein determining the number of warning messages available for reception by comparing the subsequent counter value to the initial counter value includes subtracting the initial counter value from the subsequent counter value.

23. The method of claim 22, wherein determining whether or not other warning messages available for reception have been fully received comprises:
decrementing the determined number of warning messages available for reception in response to fully receiving a warning message to generate an updated number of warning messages available for reception;
comparing the updated number of warning messages available for reception to the initial counter value; and
at least one of ceasing reception on the wireless channel when it is determined that there are no more warning messages available for reception, and maintaining reception on the wireless channel when it is determined that are more warning messages available for reception.

24. The method of claim 21, further comprising:
receiving a second indicator of a timer value;
setting a local timer according to the second indicator of the timer value; and
ceasing reception on the wireless channel when the timer crosses a threshold.

25. The method of claim 24, wherein reception is ceased when the timer crosses a threshold even if there are warning messages available for reception.

26. The method of claim 25, further comprising receiving a message indicating the availability of a subsequent counter value on a paging channel.

27. A wireless access point comprising:
means for receiving one or more warning messages;
means for generating a first indicator of the number of warning messages that an access point will broadcast to access terminals; and
means for transmitting the first indicator to one or more access terminals in response to receiving the one or more and subsequently received warning messages.

28. The wireless access point of claim 27, wherein said transmitting means is configured to transmit an indication of a change of the first indicator in response to a respective change of the first indicator.

29. The wireless access point of claim 27, wherein the first indicator is a list of warning message identifiers, and wherein the list includes a respective identifier for each of the one or more received warning messages.

30. The wireless access point of claim 29, further comprising
means for receiving one or more additional warning messages;
means for updating the list to include a respective identifier for each of the one or more additional warning messages;
means for transmitting a message to indicate that the list has been updated; and
means for transmitting the updated list and the one or more received warning messages to one or more access terminals.

31. The wireless access point of claim 29, further comprising:
means for determining whether or not each of the received warning messages continues to be valid;
means for deleting invalid warning message identifiers from the list;
means for transmitting a message to indicate that the list has been updated; and
means for transmitting the updated list and the one or more valid warning messages to one or more access terminals.

32. The wireless access point of claim 27, further comprising:
means for determining a timer value, wherein the timer value is determined at least partially as a function of a delivery delay associated with the received warning messages; and
means for transmitting an indicator of the timer value to one or more access terminals.

33. The wireless access point of claim 27, wherein the first indicator is a counter value, and the access point further comprises:
means for scheduling the transmission of the one or more received warning messages;
means for changing the counter value in response to receiving the one or more warning messages so that the counter value provides an indication of the number of warning messages scheduled for transmission; and
means for transmitting a second indicator to one or more access terminals, the second indicator providing an indication of the counter value.

34. The wireless access point of claim 33, further comprising:
means for determining whether or not each of the received warning messages is valid; and
means for incrementing the counter value as a function of the number of the received warning messages determined to be valid.

35. The wireless access point of claim 33, further comprising:
determining whether or not each of the received warning messages continues to be valid; and
wherein changing the counter value includes at least one of incrementing the counter value as a function of the number of received warning messages determined to be valid and decrementing the counter value as a function of the number of the received warning messages determined to be invalid.

36. The wireless access point of claim 33, further comprising means for broadcasting an alert message including the counter value.

37. The wireless access point of claim 36, wherein the alert message is a paging message.

38. The wireless access point of claim 33, further comprising:
means for determining a timer value, wherein the timer value is determined at least partially as a function of a delivery delay associated with the one or more received warning message; and
means for transmitting a third indicator to one or more access terminals, the third indicator providing an indication of the timer value.

39. A wireless access terminal comprising:
means for receiving a first indicator of the number of warning messages that an access point will broadcast to access terminals; and
means for maintaining open reception on the wireless channel until at least one of: all the warning messages available as indicated by the first indicator are received and the access point instructs the access terminal to stop reception.

40. The wireless access terminal of claim 39, further comprising means for receiving an indication of a change of the first indicator in response to a respective change of the first indicator.

41. The wireless access terminal of claim 39, wherein the first indicator is a list of warning messages with respective identifiers, the access terminal further comprising:
means for maintaining open reception on a wireless channel until at least one warning message with a respective identifier on the list has been fully received;
means for determining whether or not other warning messages with respective identifiers on the list have been fully received; and
means for maintaining open reception on the wireless channel when there are warning messages with respective identifiers on the list that have not be fully received.

42. The wireless access terminal of claim 41, further comprising:
means for determining whether or not a new list is available when there are no more warning messages with respective identifiers on the list that have not be fully received; and
at least one of means for ceasing reception on the wireless channel when it is determined that there is not a new list available, and means for receiving the new list when it is determined that there is a new list available.

43. The wireless access terminal of claim 42, wherein a new list includes at least one of a list including new entries and a list including at least one warning message identifier from the previous list and at least one new warning message identifier.

44. The wireless access terminal of claim 41, further comprising:
means for receiving a second indicator of a timer value;
means for setting a local timer according to the second indicator of the timer value; and
means for ceasing reception on the wireless channel when the timer crosses a threshold.

45. The wireless access terminal of claim 44, wherein reception is ceased even if there are warning messages with respective identifiers on the list that have not been fully received.

46. The wireless access terminal of claim 39, wherein the first indicator is an indicator of a counter value maintained at the access point, the access terminal further comprising:
means for receiving a subsequent counter value;
means for determining a number of warning messages available for reception by comparing the subsequent counter value to the initial counter value;
means for maintaining open reception on a wireless channel until at least one warning message has been fully received;
means for determining whether or not other warning messages available for reception have been fully received; and
means for maintaining open reception on the wireless channel when there are warning messages have not be fully received.

47. The wireless access terminal of claim 46, wherein determining the number of warning messages available for reception by comparing the subsequent counter value to the initial counter value includes subtracting the initial counter value from the subsequent counter value.

48. The wireless access terminal of claim 46, wherein said means for determining whether or not other warning messages available for reception have been fully received comprises:
means for decrementing the determined number of warning messages available for reception in response to fully receiving a warning message to generate an updated number of warning messages available for reception;
means for comparing the updated number of warning messages available for reception to the initial counter value; and
at least one of means for ceasing reception on the wireless channel when it is determined that there are no more warning messages available for reception, and means for maintaining reception on the wireless channel when it is determined that are more warning messages available for reception.

49. The wireless access terminal of claim 46, further comprising:
means for receiving a second indicator of a timer value;
means for setting a local timer according to the second indicator of the timer value; and
means for ceasing reception on the wireless channel when the timer crosses a threshold.

50. The wireless access terminal of claim 49, wherein reception is ceased when the timer crosses a threshold even if there are warning messages available for reception.

51. The wireless access terminal of claim 50, further comprising means for receiving a message indicating the availability of a subsequent counter value on a paging channel.

52. A wireless access point comprising:
a controller configured to execute code; and
non-transitory computer readable memory storing code that when executed by the controller is configured to:
receive one or more warning messages;
generate a first indicator of the number of warning messages that an access point will broadcast to access terminals; and
transmit the first indicator to one or more access terminals in response to receiving the one or more and subsequently received warning messages.

53. The wireless access point of claim 52, wherein non-transitory computer readable memory further storing code that when executed by the controller is configured to transmit an indication of a change of the first indicator in response to a respective change of the first indicator.

54. The wireless access point of claim 52, wherein the first indicator is a list of warning message identifiers, and wherein the list includes a respective identifier for each of the one or more received warning messages.

55. The wireless access point of claim 54, wherein non-transitory computer readable memory further storing code that when executed by the controller is configured to:
receive one or more additional warning messages;
update the list to include a respective identifier for each of the one or more additional warning messages;
transmit a message to indicate that the list has been updated; and
transmit the updated list and the one or more received warning messages to one or more access terminals.

56. The wireless access point of claim 54, wherein non-transitory computer readable memory further storing code that when executed by the controller is configured to:
determine whether or not each of the received warning messages continues to be valid;
delete invalid warning message identifiers from the list;
transmit a message to indicate that the list has been updated; and
transmit the updated list and the one or more valid warning messages to one or more access terminals.

57. The wireless access point of claim 52, wherein non-transitory computer readable memory further storing code that when executed by the controller is configured to:
determine a timer value, wherein the timer value is determined at least partially as a function of a delivery delay associated with the received warning messages; and
transmit an indicator of the timer value to one or more access terminals.

58. The wireless access point of claim 52, wherein the first indicator is a counter value, and wherein non-transitory computer readable memory further storing code that when executed by the controller is configured to:
schedule the transmission of the one or more received warning messages;
change the counter value in response to receiving the one or more warning messages so that the counter value provides an indication of the number of warning messages scheduled for transmission; and
transmit a second indicator to one or more access terminals, the second indicator providing an indication of the counter value.

59. The wireless access point of claim 58, wherein non-transitory computer readable memory further storing code that when executed by the controller is configured to:
determine whether or not each of the received warning messages is valid; and
increment the counter value as a function of the number of the received warning messages determined to be valid.

60. The wireless access point of claim 58, wherein non-transitory computer readable memory further storing code that when executed by the controller is configured to:
determine whether or not each of the received warning messages continues to be valid; and
wherein changing the counter value includes at least one of incrementing the counter value as a function of the number of received warning messages determined to be valid and decrementing the counter value as a function of the number of the received warning messages determined to be invalid.

61. The wireless access point of claim 58, wherein non-transitory computer readable memory further storing code that when executed by the controller is configured to broadcast an alert message including the counter value.

62. The wireless access point of claim 61, wherein the alert message is a paging message.

63. The wireless access point of claim 58, wherein non-transitory computer readable memory further storing code that when executed by the controller is configured to:
determine a timer value, wherein the timer value is determined at least partially as a function of a delivery delay associated with the one or more received warning message; and
transmit a third indicator to one or more access terminals, the third indicator providing an indication of the timer value.

64. A wireless access terminal comprising:
a controller configured to execute code; and
non-transitory computer readable memory storing code that when executed by the controller is configured to:
receive a first indicator of the number of warning messages that an access point will broadcast to access terminals; and
maintain open reception on the wireless channel until at least one of: all the warning messages available as indicated by the first indicator are received and the access point instructs the access terminal to stop reception.

65. The wireless access terminal of claim 64, wherein non-transitory computer readable memory further storing code that when executed by the controller is configured to receive an indication of a change of the first indicator in response to a respective change of the first indicator.

66. The wireless access terminal of claim 64, wherein the first indicator is a list of warning messages with respective identifiers, wherein non-transitory computer readable memory further storing code that when executed by the controller is configured to:
maintain open reception on a wireless channel until at least one warning message with a respective identifier on the list has been fully received;
determine whether or not other warning messages with respective identifiers on the list have been fully received; and
maintain open reception on the wireless channel when there are warning messages with respective identifiers on the list that have not be fully received.

67. The wireless access terminal of claim 66, wherein non-transitory computer readable memory further storing code that when executed by the controller is configured to:
determine whether or not a new list is available when there are no more warning messages with respective identifiers on the list that have not be fully received; and
at least one of cease reception on the wireless channel when it is determined that there is not a new list available, and receive the new list when it is determined that there is a new list available.

68. The wireless access terminal of claim 67, wherein a new list includes at least one of a list including new entries and a list including at least one warning message identifier from the previous list and at least one new warning message identifier.

69. The wireless access terminal of claim 66, wherein non-transitory computer readable memory further storing code that when executed by the controller is configured to:
receive a second indicator of a timer value;
set a local timer according to the second indicator of the timer value; and
cease reception on the wireless channel when the timer crosses a threshold.

70. The wireless access terminal of claim 69, wherein reception is ceased even if there are warning messages with respective identifiers on the list that have not been fully received.

71. The wireless access terminal of claim 64, wherein the first indicator is an indicator of a counter value maintained at the access point, wherein non-transitory computer readable memory further storing code that when executed by the controller is configured to:
receive a subsequent counter value;
determine a number of warning messages available for reception by comparing the subsequent counter value to the initial counter value;
maintain open reception on a wireless channel until at least one warning message has been fully received;
determine whether or not other warning messages available for reception have been fully received; and
maintain open reception on the wireless channel when there are warning messages have not be fully received.

72. The wireless access terminal of claim 71, wherein determining the number of warning messages available for reception by comparing the subsequent counter value to the initial counter value includes subtracting the initial counter value from the subsequent counter value.

73. The wireless access terminal of claim 72, wherein non-transitory computer readable memory further storing code that when executed by the controller is configured to:
decrement the determined number of warning messages available for reception in response to fully receiving a warning message to generate an updated number of warning messages available for reception;
compare the updated number of warning messages available for reception to the initial counter value; and
at least one of cease reception on the wireless channel when it is determined that there are no more warning messages available for reception, and maintain reception on the wireless channel when it is determined that are more warning messages available for reception.

74. The wireless access terminal of claim 71, wherein non-transitory computer readable memory further storing code that when executed by the controller is configured to:
receive a second indicator of a timer value;
set a local timer according to the second indicator of the timer value; and
cease reception on the wireless channel when the timer crosses a threshold.

75. The wireless access terminal of claim 74, wherein reception is ceased when the timer crosses a threshold even if there are warning messages available for reception.

76. The wireless access terminal of claim 75, wherein non-transitory computer readable memory further storing code that when executed by the controller is configured to receive a message indicating the availability of a subsequent counter value on a paging channel.

77. A computer program product comprising a computer readable medium further comprising::
Code for causing at least one computer to:
receive one or more warning messages;
generate a first indicator of the number of warning messages that an access point will broadcast to access terminals; and
transmit the first indicator to one or more access terminals in response to receiving the one or more and subsequently received warning messages.

78. A computer program product comprising a computer readable medium further comprising:
Code for causing at least one computer to:
receive a first indicator of the number of warning messages that an access point will broadcast to access terminals; and
maintain open reception on the wireless channel until at least one of: all the warning messages available as indicated by the first indicator are received and the access point instructs the access terminal to stop reception.
